(19) United States
(12) Patent Application Publication
(10) Pub. No.: US 2026/0315332 A1
(43) Pub. Date: Oct. 15, 2026

(54) ENTERAL FEEDING SYSTEM

(71) Applicants: HEATHER DOMINGUES, MATAWAN, NJ (US); ANTHONY PEZELLO, MATAWAN, NJ (US)

(72) Inventors: HEATHER DOMINGUES, MATAWAN, NJ (US); ANTHONY PEZELLO, MATAWAN, NJ (US)

(21) Appl. No.: 19/173,928

(22) Filed: Apr. 9, 2025

(51) Int. Cl. A61J 15/00

(52) U.S. Cl. CPC A61J 15/0076; A61J 15/0015

(57) ABSTRACT

The enteral feeding system is a therapeutic device. The enteral feeding system is for use by a patient. The enteral feeding system is for use with the reservoir structure of an enteral feeding structure. The enteral feeding system is configured for use with the gastric catheter of the enteral feeding structure. The enteral feeding system forms a stand that supports the enteral feeding structure. The enteral feeding system includes a pedestal structure, a stanchion structure, and a hose anchor. The stanchion structure attaches to the pedestal structure. The hose anchor attaches to the pedestal structure. The stanchion structure secures the reservoir structure to the enteral feeding system. The hose anchor secures the gastric catheter to the enteral feeding system.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

Not Applicable

### SUMMARY OF INVENTION

The enteral feeding system is a therapeutic device. The enteral feeding system is adapted for use by a patient. The enteral feeding system is configured for use with the reservoir structure of an enteral feeding structure. The enteral feeding system is configured for use with the gastric catheter of the enteral feeding structure. The enteral feeding system forms a stand that supports the enteral feeding structure. The enteral feeding system comprises a pedestal structure, a stanchion structure, and a hose anchor. The stanchion structure attaches to the pedestal structure. The hose anchor attaches to the pedestal structure. The stanchion structure secures the reservoir structure to the enteral feeding system. The hose anchor secures the gastric catheter to the enteral feeding system.

These together with additional objects, features and advantages of the enteral feeding system will be readily apparent to those of ordinary skill in the art upon reading the following detailed description of the presently preferred, but nonetheless illustrative, embodiments when taken in conjunction with the accompanying drawings.

In this respect, before explaining the current embodiments of the enteral feeding system in detail, it is to be understood that the enteral feeding system is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the enteral feeding system.

It is therefore important that the claims be regarded as including such equivalent construction insofar as they do not depart from the spirit and scope of the enteral feeding system. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a front view of an embodiment of the disclosure.

FIG. 2 is a side view of an embodiment of the disclosure.

FIG. 3 is a side view of an embodiment of the disclosure.

FIG. 4 is a top view of an embodiment of the disclosure.

FIG. 5 is a rear view of an embodiment of the disclosure.

FIG. 6 is an in-use view of an embodiment of the disclosure.

FIG. 7 is an in-use view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

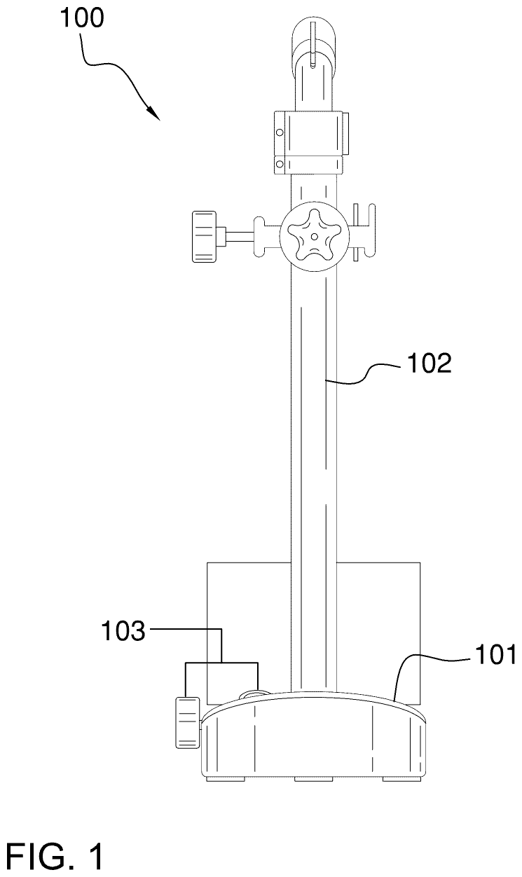

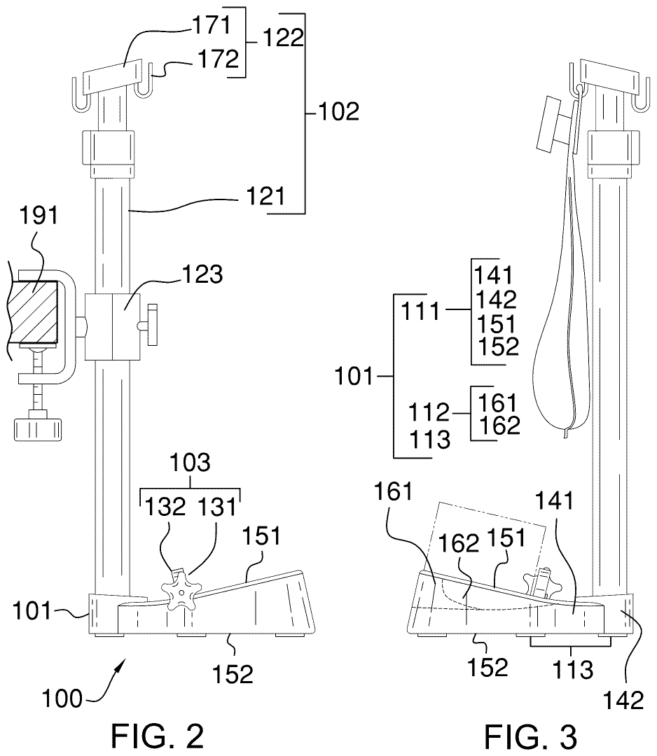

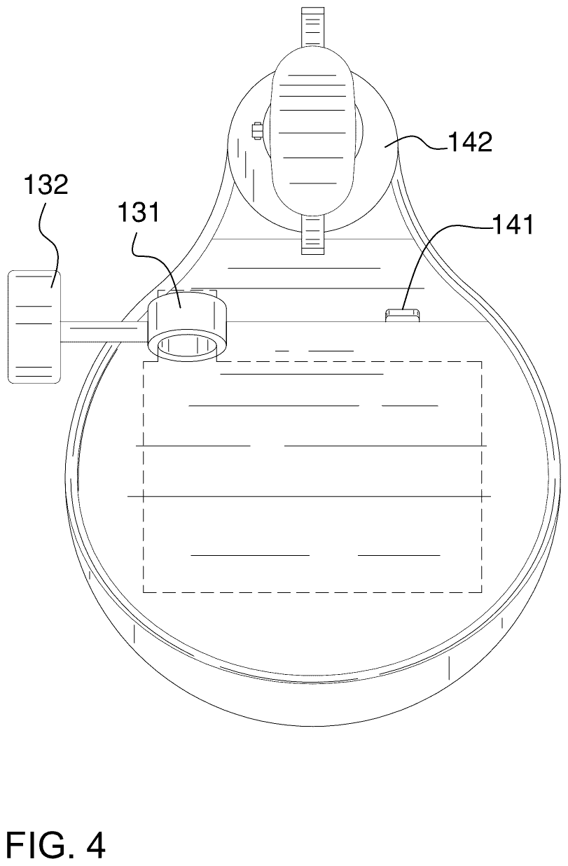

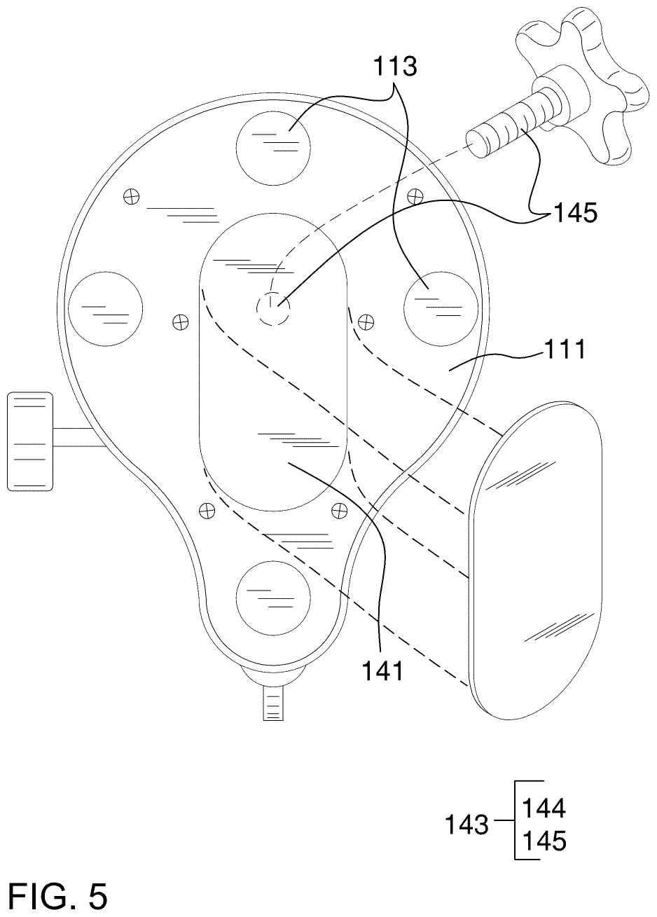

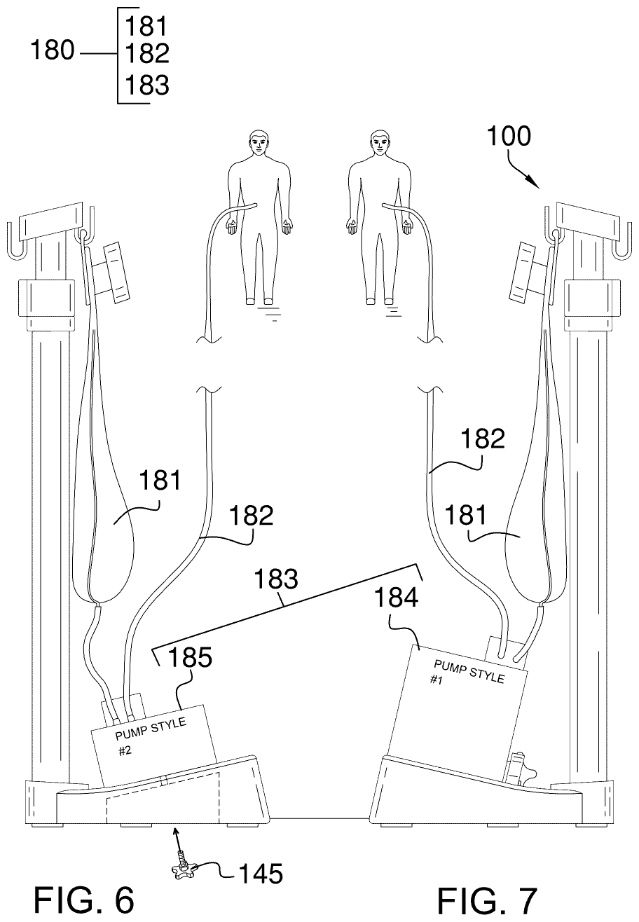

Detailed reference will now be made to one or more potential embodiments of the disclosure, which are illustrated in FIGS. 1 through 6.

The enteral feeding system 100 (hereinafter invention) is a therapeutic device. The invention 100 is adapted for use by a patient. The invention 100 is configured for use with the reservoir structure 181 of an enteral feeding structure 180. The invention 100 is configured for use with the gastric catheter 182 of the enteral feeding structure 180. The invention 100 forms a stand that supports the enteral feeding structure 180. The invention 100 comprises a pedestal structure 101, a stanchion structure 102, and a hose anchor 103. The stanchion structure 102 attaches to the pedestal structure 101. The hose anchor 103 attaches to the pedestal structure 101. The stanchion structure 102 secures the reservoir structure 181 to the invention 100. The hose anchor 103 secures the gastric catheter 182 to the invention 100.

The enteral feeding structure 180 is a therapeutic structure. The enteral feeding structure 180 provides a liquid phase nutrition compound to the patient. The enteral feeding structure 180 stores the liquid phase nutrition compound. The enteral feeding structure 180 transports the liquid phase nutrition compound to the patient. The enteral feeding structure 180 comprises a reservoir structure 181, a gastric catheter 182, and a pump structure 183. The reservoir structure 181 forms a reservoir the stores the liquid phase nutrition compound. The gastric catheter 182 is a catheter. The gastric catheter 182 is formed as a hose like structure. The gastric catheter 182 forms the flow path that transports the liquid phase nutrition compound from the reservoir structure 181 to the patient. The pump structure 183 is a mechanical device.

The pump structure 183 generates a pressure differential that transports the liquid phase nutrition compound from the reservoir structure 181 to the patient through the gastric catheter 182. The pump structure 183 is selected from the group consisting of a mounted pump structure 184 and a bolted pump structure 185. The mounted pump structure 184 is mounted on the pedestal structure 101. The bolted pump structure 185 is bolted to the pedestal structure 101.

The pedestal structure 101 is a load bearing structure. The pedestal structure 101 is a roughly disk shaped structure. The pedestal structure 101 forms the final link in the load path that transfers the load of the invention 100 to a supporting surface. The pedestal structure 101 forms the structure that elevates the enteral feeding structure 180 above the supporting surface. The pedestal structure 101 comprises a disk structure 111, a splash guard structure 112, and a footer structure 113.

The disk structure 111 is a roughly prism shaped structure. The disk structure 111 has a disk structure. The disk structure 111 has an irregular prism shape. The disk structure 111 forms the final link in the load path formed by the pedestal structure 101 that transfers the load of the invention 100 to the supporting surface. The disk structure 111 forms a pedestal that elevates the enteral feeding structure 180 above the supporting surface. The disk structure 111 comprises a circular substructure 141, a parabolic substructure 142, a pump structure 183 mount 143, a superior face 151, and an inferior face 152.

The circular substructure 141 is a substructure of the irregular prism shape of the disk structure 111 of the pedestal structure 101. The circular substructure 141 has a circular prism shape.

The parabolic substructure 142 is a substructure of the irregular prism shape of the disk structure 111 of the pedestal structure 101. The parabolic substructure 142 has a parabolic prism shape. The parabolic substructure 142 is joined with the circular substructure 141 to form a lateral disk structure. The lateral disk structure formed by the circular substructure 141 and the parabolic substructure 142 form the irregular prism structure of the pedestal structure 101.

The inferior face 152 is a congruent end of the disk structure of the pedestal structure 101. The inferior face 152 is the congruent end of the pedestal structure 101 that is proximal to the supporting surface.

The superior face 151 is a congruent end of the disk structure of the pedestal structure 101. The superior face 151 is the congruent end of the pedestal structure 101 that is distal from the supporting surface. The superior face 151 is the congruent end of the superior face 151 that is distal from the inferior face 152.

The pump structure 183 mount 143 is a fastening device. The pump structure 183 mount 143 secures the pump structure 183 of the enteral feeding structure 180 to the disk structure 111 of the pedestal structure 101.

The pump structure 183 is selected from the group consisting of a mounted pump structure 184 bracket 144 and a bolted pump structure 185 bolt 145. The mounted pump structure 184 bracket 144 forms a bracket that secures the mounted pump structure 184 to the disk structure 111. The mounted pump structure 184 bracket 144 forms a ring shaped structure that fits tightly around the mounted pump structure 184. The bolted pump structure 185 bolt 145 is a bolt. The bolted pump structure 185 bolt 145 secures the bottom of the bolted pump structure 185 to the disk structure 111.

The splash guard structure 112 is a mechanical substructure of the pedestal structure 101. The splash guard structure 112 forms a containment structure on the superior face 151 of the circular substructure 141 and the pedestal structure 101. The splash guard structure 112 forms the structure of the pedestal structure 101 that contains any fluids that spill from the enteral feeding structure 180. The splash guard structure 112 comprises a barrier structure 161 and a pan structure 162.

The barrier structure 161 is a fluid impermeable structure. The barrier structure 161 forms a vertically oriented barrier that projects away from the perimeter of the circular substructure 141 of the disk structure 111. The barrier structure 161 forms a barrier that contains any fluid spilled from the enteral feeding structure 180 within the perimeter of the circular substructure 141.

The pan structure 162 is a topographical feature that is formed in the superior face 151 of the disk structure 111. The pan structure 162 forms a well that accumulates fluids that have spilled out of the enteral feeding structure 180.

The footer structure 113 is a footing that is placed on the inferior face 152 of the disk structure 111. The footer structure 113 forms a protective barrier between the disk structure 111 and the supporting surface.

The stanchion structure 102 is a mechanical structure. The stanchion structure 102 attaches to the superior face 151 of the parabolic substructure 142. The stanchion structure 102 has a composite prism structure. The stanchion structure 102 forms a stanchion. The stanchion structure 102 forms an anchor point that secures the enteral feeding structure 180 to the invention 100. The stanchion structure 102 suspends a portion of the load of the enteral feeding structure 180 to the pedestal structure 101. The stanchion structure 102 is an adjustable structure. By adjustable is meant that the span of the length of the center axis of the composite prism structure of the stanchion structure 102 is adjustable. The stanchion structure 102 is adjusted to accommodate the form factor of the enteral feeding structure 180. The stanchion structure 102 comprises a telescopic structure 121, a keter structure 122, and a clamp structure 123.

The telescopic structure 121 forms the load bearing structure of the invention 100. The telescopic structure 121 transfers the loads of the keter structure 122 and the enteral feeding structure 180 to the supporting surface. The telescopic structure 121 forms the composite prism structure of the pedestal structure 101. The telescopic structure 121 mounts on the superior face 151 of the parabolic substructure 142 of the pedestal structure 101 such that the center axis of the telescopic structure 121 projects away from the superior face 151 in the vertical direction. The telescopic structure 121 is an adjustable structure. By adjustable is meant that the span of the length of the center axis of the telescopic structure 121 adjusts. The telescopic structure 121 forms an extension structure that bridges the reach between the keter structure 122 and the pedestal structure 101.

The keter structure 122 is a mechanical structure. The keter structure 122 is a load bearing structure. The keter structure 122 mounts on the superior congruent end of the telescopic structure 121. The keter structure 122 is a structure that suspends the superior portion of the reservoir structure 181 from the pedestal structure 101. The keter structure 122 transfers a portion of the load of the enteral feeding structure 180 to the telescopic structure 121. The telescopic structure 121 transfers the received portion of the load to the disk structure 111 of the pedestal structure 101. The keter structure 122 comprises a keter disk 171 and a plurality of keter hooks 172.

The keter disk 171 is a rigid structure. The keter disk 171 is a load bearing structure. The keter disk 171 mounts on the superior congruent end of the telescopic structure 121. The keter disk 171 forms the structure of the stanchion structure 102 that transfers the load of the plurality of keter hooks 172 to the telescopic structure 121.

Each keter hook selected from the plurality of keter hooks 172 is a hook. Each keter hook selected from the plurality of keter hooks 172 forms an anchor point the secures the reservoir structure 181 of the enteral feeding structure 180 to the telescopic structure 121 through the keter disk 171. Each keter hook selected from the plurality of keter hooks 172 transfers a portion of the load of the reservoir structure 181 to the telescopic structure 121.

The clamp structure 123 is a friction based fastening device. The clamp structure 123 secures the lateral face of the telescopic structure 121 to a horizontally oriented platform 191. The clamp structure 123 allows for the use of the invention 100 in practical situations where there is a limited surface area availability that can be dedicated to the invention 100.

The hose anchor 103 is a mechanical structure. The hose anchor 103 is the structure of the invention 100 that receives the gastric catheter 182. The hose anchor 103 secures the gastric catheter 182 into a roughly fixed position relative to the pedestal structure 101. The hose anchor 103 comprises a clamp bracket 131 and a clamp detent 132.

The clamp bracket 131 is a mechanical structure. The clamp bracket 131 mounts on the superior face 151 of the disk structure 111 of the pedestal structure 101. The clamp bracket 131 forms a structure that encloses the lateral face of the hose structure of the gastric catheter 182 of the enteral feeding structure 180. The clamp bracket 131 forms the structure of the hose anchor 103 that secures the gastric catheter 182 relative to the superior face 151 of the disk structure 111 of the pedestal structure 101.

The clamp detent 132 is a mechanical structure. The clamp detent 132 is a fastening device. The clamp detent 132 forms the structure of the hose anchor 103 that detachably secures the gastric catheter 182 in the clamp bracket 131.

The following definitions were used in this disclosure:

Align: As used in this disclosure, align refers to an arrangement of objects that are: 1) arranged in a straight plane or line; 2) arranged to give a directional sense of a plurality of parallel planes or lines; or, 3) a first line or curve is congruent to and overlaid on a second line or curve.

Anchor: As used in this disclosure, anchor means to hold an object firmly or securely.

Anchor Point: As used in this disclosure, an anchor point is a location to which a first object can be securely attached to a second object.

Associate: As used in this disclosure, the term associate is used to describe a relationship between a first object and a second object. The use of the term associated implies both: a) that the first object works with the second object in order to accomplish a task necessary for the implementation of the invention (such as joining two objects together); and, b) the relationship remains stable through the accomplishment of the task. By stable is meant that neither the first object or the second object are intended to be interchanged with a third object during the use of the invention.

Bridge: As used in this disclosure, a bridge refers to a load bearing structure that attaches a first object and to a second object such that a load bearing path is formed between the first object and the second object. The verb “to bridge” means to establish a connection (or remove a disconnection) between a first object and a second object.

Cant: As used in this disclosure, a cant is an angular deviation from one or more reference lines (or planes) such as a vertical line (or plane) or a horizontal line (or plane).

Catheter: As used in this disclosure, a catheter is a flexible tube that is inserted into the body through which images may be captured and fluids may be introduced into or removed from the body. Endoscope is a synonym for catheter. A condom catheter is a tubular structure that is designed be worn over the penis of a patient. The condom catheter transports captured excretions away from the penis of the patient.

Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.

Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.

Circle: As used in this disclosure, a circle is a curve described by the equation: c=x\hat{ }+y\hat{ }2.

Clamp: As used in this disclosure, a clamp refers to a friction based structure that temporarily fastens to the one or more faces of one or more prism structures. The clamp is used: a) to attach an externally provisioned object to the lateral face of a prism structure; or, b) to press a first face of a first prism to a second face of a second prism.

Composite Prism: As used in this disclosure, a composite prism refers to a structure that is formed from a plurality of structures selected from the group consisting of a prism structure, a pyramid structure, and a spherical structure. The plurality of selected structures may or may not be truncated or bifurcated. The plurality of prism structures are joined together such that the center axes of each of the plurality of structures are aligned. The congruent ends of any two structures selected from the group consisting of a prism structure and a pyramid structure need not be geometrically similar.

Congruent: As used in this disclosure, congruent is a term that compares a first object to a second object. Specifically, two objects are said to be congruent when: 1) they are geometrically similar; and, 2) the first object can superimpose over the second object such that the first object aligns, within manufacturing tolerances, with the second object.

Correspond: As used in this disclosure, the term correspond is used as a comparison between two or more objects wherein one or more properties shared by the two or more objects match, agree, or align within acceptable manufacturing tolerances.

Detent: As used in this disclosure, a detent is a device for positioning and holding a first object relative to a second object such that the position of the first object relative to the second object is adjustable.

Disk: As used in this disclosure, a disk is a prism-shaped object that is flat in appearance. The disk is formed from two congruent ends that are attached by a lateral face. The sum of the surface areas of two congruent ends of the prism-shaped object that forms the disk is greater than the surface area of the lateral face of the prism-shaped object that forms the disk. In this disclosure, the congruent ends of the prism-shaped structure that forms the disk are referred to as the faces of the disk.

Elevation: As used in this disclosure, elevation refers to the span of the distance in the superior direction between a specified horizontal surface and a reference horizontal surface. Unless the context of the disclosure suggest otherwise, the specified horizontal surface is the supporting surface the potential embodiment of the disclosure rests on. The infinitive form of elevation is to elevate.

Environment: As used in this disclosure, an environment refers to the physical conditions surrounding an object. The term environment is often limited to the physical conditions that the object interacts with.

Extensible: As used in this disclosure, extensible is an adjective that describes an object made of sections that fit or together such that the object can be made longer or shorter by adjusting the relative positions of the sections.

Extension Apparatus: As used in this disclosure, an extension apparatus is a mechanical structure that is used to extend or bridge the reach between any two objects.

Extension Structure: As used in this disclosure, an extension structure is an inert physical structure that is used to extend or bridge the reach between any two objects.

Exterior: As used in this disclosure, the exterior is used as a relational term that implies that an object is not contained within the boundary of a structure or a space.

Footing: As used in this disclosure, a footing refers to one of a plurality of small pedestals that combine to: a) raise an object above a supporting surface; and, b) transfer the load path of the object to the supporting surface.

Force of Gravity: As used in this disclosure, the force of gravity refers to a vector that indicates the direction of the pull of gravity on an object at or near the surface of the earth.

Form Factor: As used in this disclosure, the term form factor refers to the size and shape of an object.

Friction: As used in this disclosure, friction refers to a force that occurs between two objects that are in relative motion while in contact with each other. The force resists the relative motion of the two objects. More technically, friction refers to an exchange of energy between two objects that are in contact with each other that converts the energy of a directed relative motion between the two objects into randomly directed motions of the molecules that form both objects.

Gastric Catheter: As used in this disclosure, a gastric catheter refers to what is commonly called a feeding tube that is inserted into the esophagus for the purpose of providing nutrition to a patient. An enteral catheter is a more general term for a feeding tube that have specific connotation regarding the entry point of the nutrition into the gastrointestinal tract.

Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1. By the term essentially geometrically similar is meant that the primary shapes of two objects are geometrically similar except that there are functional items (such as fastening devices) associated with the primary shape may not maintain the ratio for geometric similarity. By the term roughly geometrically similar is meant that the form factors between the primary shape of the two objects can vary by a factor of up to 10% when the two objects are normalized to be roughly geometrically identical.

Horizontal: As used in this disclosure, horizontal is a directional term that refers to a direction that is either: 1) parallel to the horizon; 2) perpendicular to the local force of gravity, or, 3) parallel to a supporting surface. In cases where the appropriate definition or definitions are not obvious, the second option should be used in interpreting the specification. Unless specifically noted in this disclosure, the horizontal direction is always perpendicular to the vertical direction.

Hose: As used in this disclosure, a hose is a flexible hollow prism-shaped device that is used for transporting liquids and gases. When referring to a hose in this disclosure, the terms inner dimension and outer dimension are used as they would be used by those skilled in the plumbing arts.

Inferior: As used in this disclosure, the term inferior refers to a directional reference that is parallel to and in the same direction as the force of gravity when an object is positioned or used normally.

Interior: As used in this disclosure, the interior is used as a relational term that implies that an object is contained within the boundary of a structure or a space.

Keter: As used in this disclosure, a keter is an end piece that attaches to one of the congruent ends of a prism-shaped structure.

Load: As used in this disclosure, the term load refers to an object upon which a force is acting or which is otherwise absorbing energy in some fashion. Examples of a load in this sense include, but are not limited to, a mass that is being moved a distance or an electrical circuit element that draws energy. The term load is also commonly used to refer to the forces that are applied to a stationary structure.

Load of an Object: As used in this disclosure, the term load of an object refers to an object that is inserted into a load path. The load of an object refers to the sum of the forces (including the force of gravity) that are applied to the object.

Load Path: As used in this disclosure, a load path refers to a chain of one or more structures that transfers a load generated by a raised structure or object to a foundation, supporting surface, or the earth.

Negative Space: As used in this disclosure, negative space is a method of defining an object through the use of open or empty space as the definition of the object itself, or, through the use of open or empty space to describe the boundaries of an object.

Not Significantly Different: As used in this disclosure, the term not significantly different compares a specified property of a first object to the corresponding property of a reference object (reference property). The specified property is considered to be not significantly different from the reference property when the absolute value of the difference between the specified property and the reference property is less than 10.0% of the reference property value. A negligible difference is considered to be not significantly different.

One to One: When used in this disclosure, a one to one relationship means that a first element selected from a first set is in some manner connected to only one element of a second set. A one to one correspondence means that the one to one relationship exists both from the first set to the second set and from the second set to the first set. A one to one fashion means that the one to one relationship exists in only one direction. In a one to one correspondence, the first element of the first set is said to be associated to the second element of the second set to which the first element corresponds.

Pan: As used in this disclosure, a pan is a hollow containment structure. The pan has a shape selected from the group consisting of: a) a prism; and, b) a truncated pyramid. The pan has a single open face. The open face of the pan is often, but not always, the superior face of the pan. The open face is a surface selected from the group consisting of: a) a congruent end of the prism structure that forms the pan; b) a lateral face of the prism structure that forms the pan, c) the base face of the truncated pyramid structure; and, d) the truncated face of the truncated pyramid structure. A semi-enclosed pan refers to a pan wherein the closed end of prism structure of the pan and/or a portion of the lateral face of the pan is also open.

Parabola: As used in this disclosure, a parabola is a curve described by the equation: y=ax\hat{ }2+bx+c.

Paraboloid: As used in this disclosure, a paraboloid is a type of quadric surface. An elliptic paraboloid is described by the equation: (x\hat{ }2/a\hat{ }2)+(y\hat{ }2/b\hat{ }2)=z. The hyperbolic paraboloid is described by the equation: (x\hat{ }2/a\hat{ }2)−(y\hat{ }2/b\hat{ }2)=z. A paraboloid of rotation refers to an elliptic paraboloid where a=b. Unless stated otherwise within the specification, the use of the term paraboloid refers to an elliptic paraboloid.

Patient: As used in this disclosure, a patient is a person who is designated to receive a medical treatment, therapy, or service. The term patient may be extended to an animal when used within the context of the animal receiving veterinary treatment or services.

Pedestal: As used in this disclosure, a pedestal is an intermediary load bearing structure that forms a load path between two objects or structures.

Perimeter: As used in this disclosure, a perimeter is one or more curved or straight lines that bounds an enclosed area on a plane or surface. The perimeter of a circle is commonly referred to as a circumference.

Primary Shape: As used in this disclosure, the primary shape refers to a description of the rough overall geometric shape of an object that is assembled from multiple components or surfaces. The term essential primary shape is used to indicate the exclusion of functional items that are attached to the structure of the primary shape.

Primary Structure: As used in this disclosure, a primary structure refers to the component of an object that the other components attach to. The primary structure is also called the base structure.

Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.

Quadric Curve: As used in this disclosure, a quadric curve is a line that varies in the two Cartesian coordinates in an algebraically defined manner. Euclidian lines as well as the surfaces of ellipses, circles, parabolas, and hyperbolas, are examples of quadric curves. The Euclidian line is technically considered a degenerate form of a quadric curve but, unless specifically stated otherwise within this disclosure, is explicitly included in this definition. Quadric curves are described by the general algebraic form: Ax²+By²+Cxy+Dx+Ey+F=0.

Quadric Surface: As used in this disclosure, a quadric surface is a three-dimensional surface that varies in the three Cartesian coordinates in an algebraically defined manner. The conic section is a two dimensional embodiment of a quadric surface. Euclidian planes as well as the surfaces of ellipsoids, spheres, paraboloids, and cones are examples of quadric surfaces. The Euclidian plane is technically considered a degenerate form of a quadric surface but, unless specifically stated otherwise within this disclosure, is explicitly included in this definition. Quadric surfaces are described by the general algebraic form: Ax²+By²+Cz²+Dxy+Exz+Fyz+Gx+Hy+Iz+J=0.

Rack: As used in this disclosure, a rack is a structure that holds or supports and an object in a visible or exposed manner.

Reach: As used in this disclosure, reach refers to a span of distance between any two objects.

Reservoir: As used in this disclosure, a reservoir refers to a container or containment system that is configured to store a fluid.

Roughly: As used in this disclosure, roughly refers to a comparison between two objects. Roughly means that the difference between one or more parameters of the two compared objects are not significantly different.

Stanchion: As used in this disclosure, a stanchion refers to a vertically oriented prism-shaped pole, post, or support.

Stand: As used in this disclosure, a stand is a rack that is intended to hold an object such that the major axis of the object is roughly vertically oriented.

Superior: As used in this disclosure, the term superior refers to a directional reference that is parallel to and in the opposite direction of the force of gravity when an object is positioned or used normally.

Supporting Surface: As used in this disclosure, a supporting surface is a horizontal surface upon which an object is placed and to which the load of the object is transferred. This disclosure assumes that an object placed on the supporting surface is in an orientation that is appropriate for the normal or anticipated use of the object.

Suspend: As used in this disclosure, to suspend an object means to support an object such that the inferior end of the object does not form a significant portion of the load path of the object.

Teardrop Curve: As used in this disclosure, a teardrop curve refers to the curvature formed by a falling drop of water along a surface-such as a tear drop. The teardrop curve is well described by the equation: y\hat{ }2=x^{m} * (1−x) (0<x<1); or the equivalent parametric equations: x=cos(t) and y=sin(t) * sin^{m-1}(0.5 * t). Within this mathematical description, the x axis bifurcates the teardrop along the length of the tear drop. Values of m can vary, but a value between greater than 2 and less than 8 are suitable for most purposes. A teardrop shape refers to the surface formed by the rotation of a teardrop curve around a center of rotation that is aligned with the x axis of the teardrop curve.

Telescopic: As used in this disclosure, telescopic is an adjective that describes a composite prism structure made of hollow prism-shaped sections that fit or slide into each other such that the center axis of the composite prism structure can be made longer or shorter by adjusting the relative positions of the hollow prism-shaped sections.

Therapeutic: As used in this disclosure, therapeutic is an adjective that refers to a medical, ameliorative, or hygienic substance, process, procedure, or device.

Tube: As used in this disclosure, a tube is a hollow prism-shaped device formed with two open congruent ends. The tube is used for transporting liquids (including bulk solids) and gases. The line that connects the center of the first congruent face of the prism to the center of the second congruent face of the prism is referred to as the center axis of the tube or the centerline of the tube. When two tubes share the same centerline they are said to be aligned. When the centerlines of two tubes are perpendicular to each other, the tubes are said to be perpendicular to each other. In this disclosure, the terms inner dimensions of a tube and outer dimensions of a tube are used as they would be used by those skilled in the plumbing arts.

Vertical: As used in this disclosure, vertical refers to a direction that is either: 1) perpendicular to the horizontal direction; 2) parallel to the local force of gravity; or, 3) when referring to an individual object the direction from the designated top of the individual object to the designated bottom of the individual object. In cases where the appropriate definition or definitions are not obvious, the second option should be used in interpreting the specification. Unless specifically noted in this disclosure, the vertical direction is always perpendicular to the horizontal direction.

Well: As used in this disclosure, a well refers to a local gravitational minimum of the topography. By local gravitational minimum is meant that objects that flow into the well cannot escape from the well without the assistance of a force other than gravitational forces.

With respect to the above description, it is to be realized that the optimum dimensional relationship for the various components of the invention described above and in FIGS. 1 through 6 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. An enteral feeding system comprising
a pedestal structure, a stanchion structure, and a hose anchor;
wherein the stanchion structure attaches to the pedestal structure;
wherein the hose anchor attaches to the pedestal structure.

2. The enteral feeding system according to claim 1
wherein the enteral feeding system is a therapeutic device;
wherein the enteral feeding system is configured for use with the reservoir structure of an enteral feeding structure;
wherein the enteral feeding system is configured for use with the gastric catheter of the enteral feeding structure;
wherein the enteral feeding system forms a stand that supports the enteral feeding structure.

3. The enteral feeding system according to claim 2
wherein the stanchion structure secures the reservoir structure to the enteral feeding system;
wherein the hose anchor secures the gastric catheter to the enteral feeding system.

4. The enteral feeding system according to claim 3
wherein the pedestal structure is a load bearing structure;
wherein the pedestal structure is a roughly disk shaped structure;
wherein the pedestal structure forms the final link in the load path that transfers the load of the enteral feeding system to a supporting surface;
wherein the pedestal structure forms the structure that elevates the enteral feeding structure above the supporting surface.

5. The enteral feeding system according to claim 4
wherein the stanchion structure is a mechanical structure;
wherein the stanchion structure attaches to the superior face of the parabolic substructure;
wherein the stanchion structure has a composite structure;
wherein the stanchion structure forms a stanchion;
wherein the stanchion structure forms an anchor point that secures the enteral feeding structure to the enteral feeding system;
wherein the stanchion structure suspends a portion of the load of the enteral feeding structure to the pedestal structure;
wherein the stanchion structure is an adjustable structure;
wherein by adjustable is meant that the span of the length of the center axis of the composite structure of the stanchion structure is adjustable;
wherein the stanchion structure is adjusted to accommodate the form factor of the enteral feeding structure.

6. The enteral feeding system according to claim 5
wherein the hose anchor is a mechanical structure;
wherein the hose anchor is the structure of the enteral feeding system that receives the gastric catheter;
wherein the hose anchor secures the gastric catheter into a roughly fixed position relative to the pedestal structure.

7. The enteral feeding system according to claim 6
wherein the pedestal structure comprises a disk structure, a splash guard structure, and a footer structure;
wherein the disk structure has a disk structure;
wherein the disk structure has an irregular shape;
wherein the disk structure forms the final link in the load path formed by the pedestal structure that transfers the load of the enteral feeding system to the supporting surface;
wherein the disk structure forms a pedestal that elevates the enteral feeding structure above the supporting surface;
wherein the splash guard structure is a mechanical substructure of the pedestal structure;
wherein the splash guard structure forms a containment structure on the superior face of the circular substructure and the pedestal structure;
wherein the splash guard structure forms the structure of the pedestal structure that contains any fluids that spill from the enteral feeding structure;
wherein the footer structure is a footing that is placed on the inferior face of the disk structure;
wherein the footer structure forms a protective barrier between the disk structure and the supporting surface.

8. The enteral feeding system according to claim 7
wherein the stanchion structure comprises a telescopic structure and a keter structure;
wherein the keter structure mounts on the telescopic structure.

9. The enteral feeding system according to claim 8
wherein the disk structure comprises a circular substructure, a parabolic substructure, a superior face, and an inferior face;
wherein the circular substructure is a substructure of the irregular shape of the disk structure of the pedestal structure;
wherein the circular substructure has a circular shape;
wherein the parabolic substructure is a substructure of the irregular shape of the disk structure of the pedestal structure;
wherein the parabolic substructure has a parabolic shape;
wherein the parabolic substructure is joined with the circular substructure to form a lateral disk structure;
wherein the lateral disk structure formed by the circular substructure and the parabolic substructure form the irregular structure of the pedestal structure;
wherein the inferior face is a congruent end of the disk structure of the pedestal structure;
wherein the inferior face is the congruent end of the pedestal structure that is proximal to the supporting surface;
wherein the superior face is a congruent end of the disk structure of the pedestal structure;
wherein the superior face is the congruent end of the pedestal structure that is distal from the supporting surface;
wherein the superior face is the congruent end of the superior face that is distal from the inferior face.

10. The enteral feeding system according to claim 9
wherein the hose anchor comprises a clamp bracket and a clamp detent;
wherein the clamp bracket is a mechanical structure;
wherein the clamp bracket mounts on the superior face of the disk structure of the pedestal structure;
wherein the clamp bracket forms a structure that encloses the lateral face of the hose structure of the gastric catheter of the enteral feeding structure;
wherein the clamp bracket forms the structure of the hose anchor that secures the gastric catheter relative to the superior face of the disk structure of the pedestal structure;
wherein the clamp detent is a mechanical structure;
wherein the clamp detent is a fastening device;
wherein the clamp detent forms the structure of the hose anchor that detachably secures the gastric catheter in the clamp bracket.

11. The enteral feeding system according to claim 10
wherein the splash guard structure comprises a barrier structure and a pan structure;
wherein the barrier structure is a fluid impermeable structure;
wherein the barrier structure forms a vertically oriented barrier that projects away from the perimeter of the circular substructure of the disk structure;
wherein the barrier structure forms a barrier that contains any fluid spilled from the enteral feeding structure within the perimeter of the circular substructure;
wherein the pan structure is a topographical feature that is formed in the superior face of the disk structure;
wherein the pan structure forms a well that accumulates fluids that have spilled out of the enteral feeding structure.

12. The enteral feeding system according to claim 11
wherein the telescopic structure forms the load bearing structure of the enteral feeding system;
wherein the telescopic structure transfers the loads of the keter structure and the enteral feeding structure to the supporting surface;
wherein the telescopic structure forms the composite structure of the pedestal structure;
wherein the telescopic structure mounts on the superior face of the parabolic substructure of the pedestal structure such that the center axis of the telescopic structure projects away from the superior face in the vertical direction;
wherein the telescopic structure is an adjustable structure;
wherein by adjustable is meant that the span of the length of the center axis of the telescopic structure adjusts;
wherein the telescopic structure forms an extension structure that bridges the reach between the keter structure and the pedestal structure.

13. The enteral feeding system according to claim 12
wherein the keter structure is a mechanical structure;
wherein the keter structure is a load bearing structure;
wherein the keter structure mounts on the superior congruent end of the telescopic structure;
wherein the keter structure is a structure that suspends the superior portion of the reservoir structure from the pedestal structure;
wherein the keter structure transfers a portion of the load of the enteral feeding structure to the telescopic structure;
wherein the telescopic structure transfers the received portion of the load to the disk structure of the pedestal structure.

14. The enteral feeding system according to claim 13 wherein the keter structure comprises a keter disk and a plurality of keter hooks;
wherein the keter disk is a rigid structure;
wherein the keter disk is a load bearing structure;
wherein the keter disk mounts on the superior congruent end of the telescopic structure;
wherein the keter disk forms the structure of the stanchion structure that transfers the load of the plurality of keter hooks to the telescopic structure;
wherein each keter hook selected from the plurality of keter hooks is a hook;
wherein each keter hook selected from the plurality of keter hooks forms an anchor point the secures the reservoir structure of the enteral feeding structure to the telescopic structure through the keter disk;
wherein each keter hook selected from the plurality of keter hooks transfers a portion of the load of the reservoir structure to the telescopic structure.

15. The enteral feeding system according to claim 14
wherein the enteral feeding structure comprises a pump structure;
wherein the pump structure is a mechanical device;
wherein the pump structure generates a pressure differential that transports the liquid phase nutrition compound from the reservoir structure to the patient through the gastric catheter;
wherein the pump structure is selected from the group consisting of a mounted pump structure and a bolted pump structure;
wherein the mounted pump structure is mounted on the pedestal structure;
wherein the bolted pump structure is bolted to the pedestal structure;
wherein the disk structure further comprises a pump structure mount;
wherein the pump structure mount is a fastening device;
wherein the pump structure mount secures the pump structure of the enteral feeding structure to the disk structure of the pedestal structure;
wherein the pump structure is selected from the group consisting of a mounted pump structure bracket and a bolted pump structure bolt;
wherein the mounted pump structure bracket forms a bracket that secures the mounted pump structure to the disk structure;
wherein the mounted pump structure bracket forms a ring shaped structure that fits tightly around the mounted pump structure;
wherein the bolted pump structure bolt is a bolt;
wherein the bolted pump structure bolt secures the bottom of the bolted pump structure to the disk structure.

16. The enteral feeding system according to claim 15
wherein the stanchion structure further comprises a clamp structure;
wherein the clamp structure is a friction based fastening device;
wherein the clamp structure secures the lateral face of the telescopic structure to a horizontally oriented platform.
